(19) United States
(12) Patent Application Publication
(10) Pub. No.: US 2020/0239813 A1
(43) Pub. Date: Jul. 30, 2020

(54) METAL CLEANSER COMPOSITION

(71) Applicant: NICCA CHEMICAL CO., LTD., Fukui-shi, Fukui (JP)

(72) Inventors: Tetsuya MUNEISHI, Fukui-shi, Fukui (JP); Junichi NAKAJIMA, Fukui-shi, Fukui (JP); Takeshi YOSHIDA, Fukui-shi, Fukui (JP); Masahiko SHIMAKAWA, Fukui-shi, Fukui (JP); Fumitaka ITO, Fukui-shi, Fukui (JP)

(21) Appl. No.: 16/634,340

(22) PCT Filed: Jun. 28, 2018
(86) PCT No.: PCT/JP2018/024657

§ 371 Date: Jan. 27, 2020

(30) Foreign Application Priority Data
Aug. 3, 2017 (JP) 2017150818

(51) Int. Cl. C11D 3/36; C11D 1/722; C11D 1/08; C11D 3/28

(52) U.S. Cl. CPC C11D 3/362; C11D 3/28; C11D 1/08; C11D 1/722

(57) ABSTRACT

A metal cleanser composition includes: (A) at least one carboxylic acid compound selected from the group consisting of an aliphatic monocarboxylic acid, a polycarboxylic acid, and a neutral salts thereof; (B) a specific oxyalkylene group-containing compound; and (C) at least one compound selected from the group consisting of a specific organic phosphonic acid and a salt thereof, and a specific nitrogen-containing heterocycle-containing compound.

### TECHNICAL FIELD

The present invention relates to a cleanser composition used for cleaning metal.

### BACKGROUND ART

In recent years, inexpensive parts have appeared on the market as the parts market for vehicles, trains, airplanes, machine tools, and the like has become globalized, and domestic parts manufacturers are exposed to intense cost competition. For this reason, each parts manufacturer takes various measures to reduce costs in materials or manufacturing steps in order to maintain competitiveness.

Bringing the temperature during cleaning step to normal temperature is in progress as an example of reducing costs in manufacturing steps. It is possible to expect reduction in energy costs by cleaning parts, which has been performed at a relatively high temperature so far, at normal temperature since it is unnecessary to heat a cleaning bath. However, the performance, such as detergency or defoaming properties, required in the original cleaning step deteriorates, which is problematic.

In addition, there is a concern of causing rust due to a residual cleaning solution accompanied by bringing the temperature to normal temperature. With a recent increase in awareness of environmental protection, metal or alloy members which are lighter than steel materials, which have been mainly used in the related art, and contribute to a low environmental load are starting to be used, and metal materials handled by parts manufacturers have been diversified. For this reason, the cleaning solution is required to have better rust preventive properties with respect to various metal and alloy members than that in the related art.

A cleaning method in which the surface of metal is cleaned with a cleaning solution containing moisture and is then rinsed with a rinsing solution is proposed in Patent Literature 1 that cleaning and rinsing are performed using (1) a cleaning solution and a rinsing solution which contains a water-soluble inorganic rust inhibitor that is not adsorbed by activated carbon or (2) a cleaning solution and a rinsing solution both of which contain a water-soluble inorganic rust inhibitor that is not adsorbed by activated carbon, waste rinse water after rinsing is treated with activated carbon, an organic substance in the waste rinse water is adsorbed and removed, and the thus obtained aqueous solution is reused as a rinsing solution containing a water-soluble inorganic rust inhibitor.

A cleanser composition for a hard surface which contains at least one carboxylic acid compound selected from the group consisting of an aliphatic monocarboxylic acid, a polycarboxylic acid, and neutral salts thereof, a specific first oxyalkylene group-containing compound, a specific second oxyalkylene group-containing compound, and a specific oxypropylene group-containing compound is proposed in Patent Literature 2.

### CITATION LIST

### Patent Literature

[Patent Literature 1] Japanese Unexamined Patent Publication No. H9-279372
[Patent Literature 2] PCT International Publication No. WO2016/140195

### SUMMARY OF INVENTION

### Technical Problem

However, in the method disclosed in Patent Literature 1, in a case where a cleaning step is performed at normal temperature, detergency and defoaming properties deteriorate, and rust preventive properties are not sufficient. Therefore, there is a problem in that rust is generated after cleaning alloy members. Although the cleanser composition disclosed in Patent Literature 2 can maintain detergency and defoaming properties at normal temperature, it cannot be said that the rust preventive properties with respect to alloy members are sufficient.

The present invention has been made from the viewpoint of the above-described circumstances, and an object of the present invention is to provide a metal cleanser composition with which it is possible to obtain sufficient detergency for various kinds of metal while sufficiently suppressing generation of bubbles even at room temperature and rust hardly occurs on the surface of metal after cleaning.

### Solution to Problem

The present invention for solving the above-described problems provides a metal cleanser composition including: (A) at least one carboxylic acid compound selected from the group consisting of an aliphatic monocarboxylic acid, a polycarboxylic acid, and a neutral salt thereof; (B) a compound represented by General Formula (B); and (C) at least one compound selected from the group consisting of a compound represented by General Formula (C-1) and a salt thereof, a compound represented by General Formula (C-2), and a compound represented by General Formula (C-3).

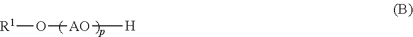

[In Formula (B), R¹ represents an alkyl group having 1 to 8 carbon atoms or an alkenyl group having 2 to 8 carbon atoms, AO represents an oxyalkylene group having 2 to 4 carbon atoms, and p represents an average addition molar number of the oxyalkylene group and is within a range of 1 to 5.]

R²—(H₂PO₃)_{q} (C-1)

[In Formula (C-1), R² represents a linear or branched alkyl group or alkenyl group having 2 to 30 carbon atoms, and q represents an integer of 1 to 10.]

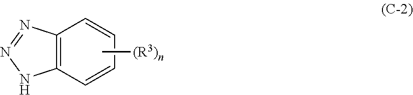

[In Formula (C-2), R³ represents a linear or branched alkyl group having 1 to 10 carbon atoms or a linear or branched alkenyl group having 2 to 10 carbon atoms, and n represents 0 or 1.]

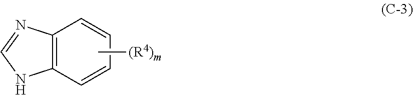

[In Formula (C-3), R⁴ represents a linear or branched alkyl group having 1 to 20 carbon atoms or a linear or branched alkenyl group having 2 to 20 carbon atoms, and m represents 0 or 1.]

According to the metal cleanser composition of the present invention, with the above-described configuration, it is possible to obtain sufficient detergency for various kinds of metal while sufficiently suppressing generation of bubbles even at room temperature and rust hardly occurs on the surface of metal after cleaning.

In the metal cleanser composition according to the present invention, it is preferable that a content of (A) is 1 to 40 mass %, a content of (B) is 0.1 to 15 mass %, and a content of (C) is 0.001 to 5.0 mass % based on a total amount of the metal cleanser composition.

In addition, the metal cleanser composition according to the present invention preferably includes: a compound in which, in Formula (B), R¹ represents a linear or branched alkyl group or alkenyl group having 8 carbon atoms, AO represents an oxyalkylene group having 2 to 4 carbon atoms, and p is within a range of 1 to 5, as the compound represented by General Formula (B).

### Advantageous Effects of Invention

According to the present invention, it is possible to provide a metal cleanser composition with which it is possible to obtain sufficient detergency for various kinds of metal while sufficiently suppressing generation of bubbles even at room temperature and rust hardly occurs on the surface of metal after cleaning.

### BRIEF DESCRIPTION OF DRAWINGS

FIG. 1 is a diagram illustrating a configuration of an evaluation sample used in a detergency evaluation test.

### DESCRIPTION OF EMBODIMENTS

A metal cleanser composition of the present embodiment includes: (A) at least one carboxylic acid compound selected from the group consisting of an aliphatic monocarboxylic acid, a polycarboxylic acid, and neutral salts thereof; (B) a specific oxyalkylene group-containing compound; and (C) at least one compound selected from the group consisting of a specific organic phosphonic acid and a salt thereof, and a specific nitrogen-containing heterocycle-containing compound.

According to the metal cleanser composition of the present embodiment, it is possible to obtain sufficient detergency for various kinds of metal while sufficiently suppressing generation of bubbles even at room temperature and rust hardly occurs on the surface of metal after cleaning. Accordingly, in cleaning of a metal or alloy member, it is possible to perform a cleaning step, which has been performed at a high temperature so far, at normal temperature and to expect reduction in energy costs since it is unnecessary to heat a cleaning bath.

An example of an aliphatic monocarboxylic acid used as the above-described component (A) includes a linear or branched, unsaturated or saturated aliphatic monocarboxylic acid having 6 to 24 carbon atoms which may have a hydroxyl group. Specific examples of such an aliphatic monocarboxylic acid include caproic acid, caprylic acid, enanthic acid, pelargonic acid, capric acid, lauric acid, myristic acid, palmitic acid, palmitoleic acid, margaric acid, stearic acid, oleic acid, vaccenic acid, linoleic acid, (9,12,15)-linolenic acid, (6,9,12)-linolenic acid, eleostearic acid, arachidic acid, (8,11)-eicosadienoic acid, (5,8,11)-eicosatrienoic acid, arachidonic acid, behenic acid, lignoceric acid, nervonic acid, 2-ethylhexanoic acid, 2-methylhexanoic acid, 2-methylheptanoic acid, trimethylhexanoic acid, isostearic acid, and 12-hydroxystearic acid. These can be used singly or in combination of two or more thereof.

An example of a neutral salt of an aliphatic monocarboxylic acid used as the above-described component (A) includes a neutral salt obtained by neutralizing the above-described aliphatic monocarboxylic acid using alkali metal, amine compound, or the like. Here, examples of alkali metal include sodium, potassium, and lithium, and examples of amine compounds include ammonia, monoethanolamine, diethanolamine, and triethanolamine. These can be used singly or in combination of two or more thereof.

The aliphatic monocarboxylic acid and a neutral salt thereof used as the above-described component (A) are preferably a linear or branched, unsaturated or saturated aliphatic monocarboxylic acid and a neutral salt thereof having 6 to 18 carbon atoms and more preferably a linear or branched, unsaturated or saturated aliphatic monocarboxylic acid and a neutral salt thereof having 6 to 12 carbon atoms from the viewpoint of detergency. These can be used singly or in combination of two or more thereof.

An example of the polycarboxylic acid used as the above-described component (A) includes a polycarboxylic acid having a weight-average molecular weight of 500 to 150,000 and is preferably a polycarboxylic acid having a weight-average molecular weight of 1,000 to 100,000 and more preferably a polycarboxylic acid having a weight-average molecular weight of 1,000 to 50,000 from the viewpoints of detergency and handling properties. In the present specification, the weight-average molecular weight of the polycarboxylic acid means a value measured through gel permeation chromatography (GPC).

Examples of polycarboxylic acids include a homopolymer or a copolymer synthesized through a well-known radical polymerization method using vinyl monomers, such as acrylic acid, methacrylic acid, maleic acid, fumaric acid, and itaconic acid, which have a carboxyl group. A commercially available polycarboxylic acid may be used. A copolymerizable monomer having no carboxyl group may be used for radical polymerization within the scope not impairing the present invention in addition to the above-described monomers. Examples of such monomers include vinyl monomers such as ethylene, vinyl chloride, and vinyl acetate, acrylamides, acrylates, and methacrylates. Acrylates and methacrylates having an alkyl group having 1 to 3 carbon atoms or an alkenyl group having 2 to 3 carbon atoms are preferable. The alkyl group or the alkenyl group may have a substituent such as a hydroxyl group. Examples of such acrylates and methacrylates include methyl acrylate, methyl methacrylate, ethyl acrylate, ethyl methacrylate, 2-hydroxyethyl acrylate, 2-hydroxyethyl methacrylate, propyl acrylate, and propyl methacrylate. The weight ratio of a vinyl monomer having a carboxyl group to a copolymerizable monomer having no carboxyl group is preferably 100:0 to 50:50, more preferably 100:0 to 70:30, and still more preferably 100:0 to 90:10 from the viewpoint of detergency. The above-described copolymerizable monomer can be used singly or in combination of two or more thereof.

An example of a neutral salt of a polycarboxylic acid used as the above-described component (A) includes a neutral salt obtained by neutralizing the above-described polycarboxylic acid using alkali metal, amine compound, or the like. Here, examples of alkali metal include sodium, potassium, and lithium, and examples of amine compounds include ammonia, monoethanolamine, diethanolamine, and triethanolamine. These can be used singly or in combination of two or more thereof.

A method for producing a polycarboxylic acid and a neutral salt thereof is not particularly limited, but examples thereof include a method for adding a radical polymerization initiator to an aqueous solution of the above-described monomer and/or a salt thereof to cause a thermal reaction for 2 to 5 hours at 30° C. to 150° C. At this time, alcohols such as methyl alcohol, ethyl alcohol, and isopropyl alcohol or aqueous solvents such as acetone may be added to the aqueous solution of the above-described monomer and/or a salt thereof. In addition, the radical polymerization initiator to be used is not particularly limited, but examples thereof include persulfate such as potassium persulfate, sodium persulfate, and ammonium persulfate, a redox polymerization initiator using a combination of persulfate, sodium bisulfite, and the like, hydrogen peroxide, and a water-soluble azo polymerization initiator. These radical polymerization initiators can be used singly or in combination of two or more thereof. A chain transfer agent (for example, octyl thioglycolate) may be added for the purpose of adjusting the degree of polymerization during radical polymerization.

As a polycarboxylic acid and a neutral salt thereof used as the component (A), a homopolymer of acrylic acid, methacrylic acid, or a maleic acid, or a neutral salt thereof or a copolymer containing any one or more of acrylic acid, methacrylic acid, or maleic acid as monomer components, or a neutral salt thereof is preferable, and a homopolymer of acrylic acid or a neutral salt thereof is more preferable from this viewpoint of detergency. The above-described polycarboxylic acid and the neutral salt thereof can be used singly or in combination of two or more thereof.

The formulation amount of the component (A) in the metal cleanser composition is appropriately set according to the purpose of use, and is preferably 1 to 40 mass % and more preferably 1 to 20 mass % based on the total amount of the metal cleanser composition from the viewpoints of detergency, rust preventive properties, and economical efficiency.

Next, the (B) specific oxyalkylene group-containing compound according to the present embodiment will be described. An example of such a compound includes a compound represented by General Formula (B).

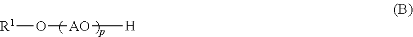

[In Formula (B), R¹ represents an alkyl group having 1 to 8 carbon atoms or an alkenyl group having 2 to 8 carbon atoms, AO represents an oxyalkylene group having 2 to 4 carbon atoms, and p represents an average addition molar number of the oxyalkylene group and is within a range of 1 to 5.]

Specific examples of the compound represented by General Formula (B) include an ethyl alcohol AO (1 to 5) adduct, an isopropyl alcohol AO (1 to 5) adduct, a butyl alcohol AO (1 to 5) adduct, a hexyl alcohol AO (1 to 5) adduct, an octyl alcohol AO (1 to 5) adduct, a 2-ethylhexyl alcohol AO (1 to 5) adduct, and a 2-octyl alcohol AO (1 to 5) adduct. The numbers in parentheses represent the number of moles.

The oxyalkylene groups of the above-described AO may be the same as or different from each other. In a case where these are different from each other, the addition form thereof may be block addition, random addition, or alternate addition.

The compound represented by General Formula (B) is preferably a compound in which, in General Formula (B), R⁴ is an alkyl group having 4 to 8 carbon atoms or an alkenyl group having 4 to 8 carbon atoms, and p is 1 to 5, and is more preferably a compound in which R⁴ is an alkyl group having 8 carbon atoms or an alkenyl group having 8 carbon atoms, and p is 1 to 5 from the viewpoint of defoaming properties.

Specific examples of compounds satisfying the above-described conditions include a butyl alcohol AO (1 to 5) adduct, a hexyl alcohol AO (1 to 5) adduct, an octyl alcohol AO (1 to 5) adduct, a 2-ethylhexyl alcohol AO (1 to 5) adduct, and a 2-octyl alcohol AO (1 to 5) adduct. The numbers in parentheses represent the number of moles. Among these, an octyl alcohol AO (1 to 5) adduct, a 2-ethylhexyl alcohol AO (1 to 5) adduct, and a 2-octyl alcohol AO (1 to 5) adduct are preferable and a 2-ethylhexyl alcohol AO (1 to 5) adduct is more preferable from the viewpoint of defoaming properties.

The compound represented by General Formula (B) can be used singly or in combination of two or more thereof.

The formulation amount of the component (B) in the metal cleanser composition is appropriately set according to the purpose of use, and is preferably 0.1 to 15 mass % and more preferably 0.1 to 10 mass % based on the total amount of the metal cleanser composition from the viewpoints of detergency, defoaming properties, and economical efficiency.

Next, the component (C) according to the present embodiment will be described. Examples of such compounds include a compound represented by General Formula (C-1) and a salt thereof, a compound represented by General Formula (C-2) and a salt thereof, and a compound represented by General Formula (C-3) and a salt thereof. The compounds can be used singly or in combination of two or more thereof.

R²—(H₂PO₃)_{q} (C-1)

[In Formula (C-1), R² represents a linear or branched alkyl group or alkenyl group having 2 to 30 carbon atoms, and q represents an integer of 1 to 10.]

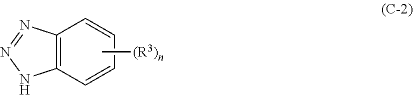

[In Formula (C-2), R³ represents a linear or branched alkyl group having 1 to 10 carbon atoms or a linear or branched alkenyl group having 2 to 10 carbon atoms, and n represents 0 or 1.]

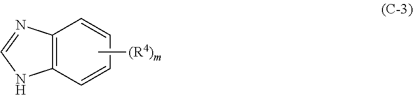

[In Formula (C-3), R⁴ represents a linear or branched alkyl group having 1 to 20 carbon atoms or a linear or branched alkenyl group having 2 to 20 carbon atoms, and m represents 0 or 1.]

The compound represented by Formula (C-1) is preferably a compound in which, in the formula, R² is a linear or branched alkyl group or alkenyl group having 4 to 22 carbon atoms and q is 1 to 5 and is more preferably a compound in which, in the formula, R² is a linear or branched alkyl group or alkenyl group having 8 to 18 carbon atoms and q is 1 to 3 from the viewpoints of rust preventive properties, detergency, and defoaming properties.

Examples of a salt of the compound represented by Formula (C-1) include a neutral salt neutralized using alkali metal, an amine compound, or the like. Here, examples of alkali metal include sodium, potassium, and lithium, and examples of amine compounds include ammonia, monoethanolamine, diethanolamine, and triethanolamine. These can be used singly or in combination of two or more thereof.

The compound represented by General Formula (C-2) is preferably a compound in which, in the formula, n is 0 (that is, unsubstituted) or a compound in which n is 1 and R³ is a linear or branched alkyl group having 1 to 8 carbon atoms or a linear or branched alkenyl group having 2 to 8 carbon atoms, and is more preferably a compound in which n is 0 (that is, unsubstituted) or a compound in which n is 1 and R³ is a linear or branched alkyl group having 1 to 5 carbon atoms or a linear or branched alkenyl group having 2 to 5 carbon atoms from the viewpoints of rust preventive properties, detergency, and defoaming properties.

The compound represented by General Formula (C-3) is preferably a compound in which, in the formula, m is 0 (that is, unsubstituted) or a compound in which m is 1 and R⁴ is a linear or branched alkyl group having 5 to 18 carbon atoms or a linear or branched alkenyl group having 5 to 18 carbon atoms, and is more preferably a compound in which m is 0 (that is, unsubstituted) or a compound in which m is 1 and R⁴ is a linear or branched alkyl group having 10 to 17 carbon atoms or a linear or branched alkenyl group having 10 to 17 carbon atoms from the viewpoints of rust preventive properties, detergency, and defoaming properties.

The compounds represented by Formula (C-1) and a salt thereof are preferable as the component (C) from the viewpoint of rust preventive properties.

The formulation amount of the component (C) in the metal cleanser composition is appropriately set according to the purpose of use, and is preferably 0.001 to 5.0 mass %, more preferably 0.005 to 3.0 mass %, still more preferably 0.01 to 3.0 mass %, still more preferably 0.01 to 2.0 mass %, and particularly preferably 0.1 to 1.0 mass % based on the total amount of the metal cleanser composition from the viewpoints of rust preventive properties, defoaming properties, detergency, and economical efficiency.

The metal cleanser composition of the present embodiment can further contain an oxyalkylene group-containing compound (hereinafter, also referred to as a component (D)) other than the above-described component (B) from the viewpoint of improving detergency and defoaming properties.

An example of such a compound includes a compound represented by General Formula (D-1).

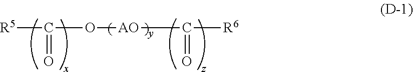

[In Formula (D-1), R⁵ represents an alkyl group having 8 to 30 carbon atoms which may have a hydroxyl group, an alkenyl group having 8 to 30 carbon atoms which may have a hydroxyl group, or a group represented by General Formula (D-2), R⁶ represents a hydrogen atom, an alkyl group having 1 to 30 carbon atoms which may have a hydroxyl group, or an alkenyl group having 2 to 30 carbon atoms which may have a hydroxyl group, x and z each independently represent 0 or 1, AO represents an oxyalkylene group having 2 to 4 carbon atoms, and y represents an average addition molar number of an oxyalkylene group and is within a range of 11 to 200. However, in a case where R⁵ is the group represented by General Formula (D-2), R⁶ is a hydrogen atom and x and z are 0.

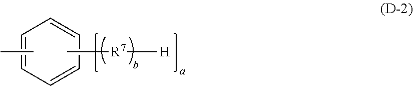

{In Formula (D-2), R⁷ represents a divalent group represented by Formula (D-3), a is an integer of 1 to 5, b is an integer of 1 to 5, and in a case where the total number of a×b is within a range of 1 to 5 and a in Formula (D-2) is 2 or more, a plurality of b's may be the same as or different from each other.

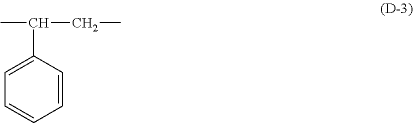

}]

Specific examples of the compound represented by General Formula (D-1) include an octyl alcohol AO (11 to 200) adduct, a decyl alcohol AO (11 to 200) adduct, a lauryl alcohol AO (11 to 200) adduct, a myristyl alcohol AO (11 to 200) adduct, a cetyl alcohol AO (11 to 200) adduct, a stearyl alcohol AO (11 to 200) adduct, an isostearyl alcohol AO (11 to 200) adduct, an oleyl alcohol AO (11 to 200) adduct, a behenyl alcohol AO (11 to 200) adduct, a tridecyl alcohol AO (11 to 200) adduct, a 2-butyloctyl alcohol AO (11 to 200) adduct, a 2-butyldecane alcohol AO (11 to 200) adduct, a 2-hexyloctyl alcohol AO (11 to 200) adduct, a 2-hexyldecane alcohol AO (11 to 200) adduct, a 2-octyldodecane alcohol AO (11 to 200) adduct, a 2-hexyldodecane alcohol AO (11 to 200) adduct, a 2-octyldodecane alcohol AO (11 to 200) adduct, a 2-decyltetradecane alcohol AO (11 to 200) adduct, a 2-dodecylhexadecane alcohol AO (11 to 200) adduct, a 2-tetradecyloctadecane alcohol AO (11 to 200) adduct, an isooctyl alcohol AO (11 to 200) adduct, a 2-ethylhexyl alcohol AO (11 to 200) adduct, an isononane alcohol AO (11 to 200) adduct, an isodecane alcohol AO (11 to 200) adduct, an isoundecane alcohol AO (11 to 200) adduct, an octane-2-ol AO (11 to 200) adduct, a 2-dodecane alcohol AO (11 to 200) adduct, a monostyrenated phenol AO (11 to 200) adduct, a distyrenated phenol AO (11 to 200) adduct, a tristyrenated phenol AO (11 to 200) adduct, a hydroxystearyl alcohol AO (11 to 200) adduct, a caprylic acid AO (11 to 200) adduct, a capric acid AO (11 to 200) adduct, a lauric acid AO (11 to 200) adduct, a myristic acid AO (11 to 200) adduct, a palmitic acid AO (11 to 200) adduct, a stearic acid AO (11 to 200) adduct, an oleic acid AO (11 to 200) adduct, a polyoxyalkylene (11 to 200) dicaprylic acid, polyoxyalkylene (11 to 200) dipalmitic acid, polyoxyalkylene (11 to 200) dioleic acid, polyoxyalkylene (11 to 200) distearic acid, an octyl ester of an octyl alcohol AO (11 to 200) adduct (that is, a polyoxyalkylene (11 to 200) octyl ether octyl ester), a decyl ester of a decyl alcohol AO (11 to 200) adduct (that is, a polyoxyalkylene (11 to 200) decyl ether decyl ester), a lauryl ester of a lauryl alcohol AO (11 to 200) adduct (that is, a polyoxyalkylene (11 to 200) lauryl ether lauryl ester), an octyl ester of a myristyl alcohol AO (11 to 200) adduct (that is, a polyoxyalkylene (11 to 200) myristyl ether octyl ester), an octyl ester of a cetyl alcohol AO (11 to 200) adduct (that is, a polyoxyalkylene (11 to 200) cetyl ether octyl ester), methyl ether of an octyl alcohol AO (11 to 200) adduct (that is, polyoxyalkylene (11 to 200) octyl ether methyl ether), ethyl ether of an octyl alcohol AO (11 to 200) adduct (that is, polyoxyalkylene (11 to 200) octyl ether ethyl ether), methyl ether of a decyl alcohol AO (11 to 200) adduct (that is, polyoxyalkylene (11 to 200) decyl ether methyl ether), methyl ether of a lauryl alcohol AO (11 to 200) adduct (that is, polyoxyalkylene (11 to 200) lauryl ether methyl ether), methyl ether of a lauryl alcohol AO (11 to 200) adduct (that is, polyoxyalkylene (11 to 200) lauryl ether ethyl ether), methyl ether of a myristyl alcohol AO (11 to 200) adduct (that is, polyoxyalkylene (11 to 200) myristyl ether methyl ether), methyl ether of a cetyl alcohol AO (11 to 200) adduct (that is, polyoxyalkylene (11 to 200) cetyl ether methyl ether), and methyl ether of a stearyl alcohol AO (II to 200) adduct (that is, polyoxyalkylene (11 to 200) stearyl ether methyl ether). The numbers in parentheses represent the number of moles.

The oxyalkylene groups of the above-described AO may be the same as or different from each other. In a case where these are different from each other, the addition form thereof may be block addition, random addition, or alternate addition.

In the compound represented by General Formula (D-1), R⁵ is preferably an alkyl group having 8 to 30 carbon atoms or an alkenyl group having 8 to 30 carbon atoms and more preferably an alkyl group having 12 to 24 carbon atoms or an alkenyl group having 12 to 24 carbon atoms from the viewpoints of detergency and defoaming properties.

In addition, in the compound represented by General Formula (D-1), it is preferable that AO is random addition of an oxyethylene group and an oxypropylene group, the formulation ratio (mass ratio) of the oxyethylene group to the oxypropylene group is oxyethylene group:oxypropylene group=20:80 to 80:20, and y is 11 to 100, and it is more preferable that AO is random addition of an oxyethylene group and an oxypropylene group, the formulation ratio (mass ratio) of the oxyethylene group to the oxypropylene group is oxyethylene group:oxypropylene group=20:80 to 80:20, and y is 11 to 80 from the viewpoints of detergency and defoaming properties.

The compound represented by General Formula (D-1) is preferably a compound in which, in General Formula (D-1), R⁵ is an alkyl group having 8 to 30 carbon atoms or an alkenyl group having 8 to 30 carbon atoms, R⁶ is a hydrogen atom, x and z are 0, AO is random addition of an oxyethylene group and an oxypropylene group, the formulation ratio (mass ratio) of the oxyethylene group to the oxypropylene group is oxyethylene group:oxypropylene group=20:80 to 80:20, and y is 11 to 100 from the viewpoints of detergency and defoaming properties.

In addition, the compound is more preferably a compound in which, in General Formula (D-1), R⁵ is an alkyl group having 12 to 24 carbon atoms or an alkenyl group having 12 to 24 carbon atoms, R⁶ is a hydrogen atom, x and z are 0, AO is random addition of an oxyethylene group and an oxypropylene group, the formulation ratio (mass ratio) of the oxyethylene group to the oxypropylene group is oxyethylene group:oxypropylene group=20:80 to 80:20, and y is 11 to 80 from the viewpoints of detergency and defoaming properties.

The compound represented by General Formula (D-1) can be used singly or in combination of two or more thereof.

The formulation amount of the component (D) in the metal cleanser composition is appropriately set according to the purpose of use, and is preferably 0.01 to 0.5 mass % and more preferably 0.01 to 0.3 mass % based on the total amount of the metal cleanser composition from the viewpoints of detergency, defoaming properties, and economical efficiency.

The metal cleanser composition of the present embodiment can further contain a compound represented by General Formula (E) from the viewpoint of improving defoaming properties.

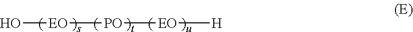

[In Formula (E), EO represents an oxyethylene group, PO represents an oxypropylene group, s and u represent average addition molar numbers of oxyethylene groups, s+u is within a range of 0 to 10, and t represents an average addition molar number of the oxypropylene group and is within a range of 1 to 100.]

Specific examples of the compound represented by General Formula (E) include HO—(PO)₁₇—H, HO—(PO)₃₄—H, HO-(EO)₁—(PO)₁₆-(EO)₁—H, and HO-(EO)_{1.5}—(PO)₂₉-(EO)_{1.5}—H.

In the compound represented by General Formula (E), it is preferable that, in General Formula (E), t is 1 to 60 and s+u is 0 to 10, or t is 61 to 100 and s+u is 0 to 5, it is more preferable that t is 1 to 60 and s+u is 0 to 10, and it is particularly preferable that t is 20 to 60 and s+u is 0 to 10, or t is 10 to 20 and s+u is 0 from the viewpoint of defoaming properties.

The compound represented by General Formula (E) can be used singly or in combination of two or more thereof.

The formulation amount of the component (E) in the metal cleanser composition is appropriately set according to the purpose of use, and is preferably 0.01 to 5 mass %, more preferably 0.05 to 5 mass %, and still more preferably 0.1 to 3 mass % based on the total amount of the metal cleanser composition from the viewpoints of detergency, defoaming properties, and economical efficiency.

The mass ratio of the component (A) to the component (B) in the metal cleanser composition of the present embodiment is preferably (A):(B)=35 to 95:5 to 65, more preferably (A):(B)=45 to 92.5:7.5 to 55, and still more preferably (A):(B)=60 to 90:10 to 40 from the viewpoint of defoaming properties.

The metal cleanser composition of the present embodiment can be formulated with a rust inhibitor other than the above-described component (C), a preservative, a surfactant, a chelating agent, an antioxidant, a coloring agent, a deodorant, an aromatic agent, and the like within the scope not impairing the effect of the present invention.

An example of a rust inhibitor includes dicarboxylic acid, and specific examples thereof include oxalic acid, malonic acid, succinic acid, glutaric acid, adipic acid, fumaric acid, maleic acid, dodecanedioic acid, eicosadienoic acid, isodocosadiendioic acid, isodocosanedioic acid, isoeicosadienedioic acid, butyloctanedioic acid, and dialkoxycarbonylisodocosadienedioic acid. The rust inhibitors can be used singly or in combination of two or more thereof. In a case of using dicarboxylic acid, it is preferable to formulate dicarboxylic acid to not exceed a preferred formulation amount of the above-described component (A).

An example of the preservative includes aromatic carboxylic acid, and specific examples thereof include benzoic acid, p-toluic acid, p-ethylbenzoic acid, p-isopropylbenzoic acid, p-tert-butylbenzoic acid, xylic acid, isophthalic acid, terephthalic acid, salicylic acid, cinnamic acid, toluic acid, hemimellitic acid, trimellitic acid, trimesic acid, hydroxybenzoic acid, dihydroxybenzoic acid, and trihydroxybenzoic acid. The preservatives can be used singly or in combination of two or more thereof. In a case where aromatic carboxylic acid overlaps with the above-described component (A), it is preferable to formulate aromatic carboxylic acid to not exceed a preferred formulation amount of the above-described component (A).

Examples of surfactants include nonionic surfactants such as a higher alcohol AO adduct, an alkyl phenol AO adduct, a fatty acid AO adduct, a polyhydric alcohol fatty acid ester alkylene oxide adduct, and higher alkylamine AO adduct, anionic surfactants such as soap, alkylbenzene sulfonate, higher alcohol sulfuric ester salt, and polyoxyethylene alkyl ether sulfate, and amphoteric surfactants such as alkylamino fatty acid salt and alkylbetaine. The surfactants can be used singly or in combination of two or more thereof. In a case where such a higher alcohol AO adduct, alkyl phenol AO adduct, and the like overlap with the above-described component (B) or (D), it is preferable to formulate them to not exceed a preferred formulation amount of the above-described component (B) or (D).

Examples of chelating agents include aminocarboxylic acid-based chelating agents such as EDTA, NTA, DTPA, HEDTA, and TTHA; and phosphonic acid-based chelating agents such as HEDP and NTMP. The chelating agents can be used singly or in combination of two or more thereof. In a case where an aminocarboxylic acid-based chelating agent overlaps with the above-described component (A), it is preferable to formulate aromatic carboxylic acid to not exceed a preferred formulation amount of the above-described component (A).

The pH of the metal cleanser composition of the present embodiment is preferably 5.0 to 14.0, more preferably 8.0 to 12.0, and particularly preferably 8.0 to 11.0 from the viewpoints of detergency and rust preventive properties. In a case where the pH is less than 5.0, the pH can be adjusted with alkalis such as sodium hydroxide, potassium hydroxide, sodium carbonate, potassium carbonate, and triethanolamine. In a case where the pH exceeds 14.0, the pH can be adjusted with acids such as hydrochloric acid, sulfuric acid, lactic acid, formic acid, and citric acid. The pH1 adjusting agents can be used singly or in combination of two or more thereof. The pH of the metal cleanser composition can be measured through a well-known method such as a glass electrode method.

The static surface tension and the dynamic surface tension of the metal cleanser composition of the present embodiment are preferably 20 to 60 mN/m and more preferably 20 to 50 mN/m from the viewpoints of detergency and rust drying properties. The static surface tension can be measured through a Wilhelmy method, and the dynamic surface tension can be measured through a maximum bubble pressure method.

Examples of metal to be cleaned by the metal cleanser composition of the present embodiment include metal such as iron, aluminum, gold, silver, copper, lead, titanium, zinc, nickel, chromium, manganese, and tin; and alloys such as aluminum alloy, copper alloy, nickel alloy, magnesium alloy, steel (stainless steel, chromium steel, manganese steel, molybdenum steel, and silicon steel), special steel (nickel-chromium-molybdenum steel, chromium steel, chromium-molybdenum steel, manganese-molybdenum steel, manganese steel, manganese-chromium steel, Yasuki steel, rolled steel, and carbon steel), and die-cast alloy (an aluminum alloy die cast, a zinc alloy die cast and a magnesium alloy die cast).

The metal cleanser composition of the present embodiment may be used as it is, or a treatment liquid prepared by diluting the composition with water may be used. Regarding the concentration of the treatment liquid, the content of the metal cleanser composition is preferably 0.01 to 50 mass %, more preferably 0.05 to 30 mass %, and still more preferably 0.1 to 15 mass % based on the total amount of the treatment liquid from the viewpoints of detergency and economical efficiency.

It is possible to suitably use tap water, well water, ion exchange water, or distilled water as water in the present embodiment.

The pH of the treatment liquid prepared by diluting the metal cleanser composition with water is preferably 5.0 to 14.0, more preferably 8.0 to 12.0, and particularly preferably 8.0 to 11.0 from the viewpoints of detergency and rust preventive properties. In a case where the pH is less than 5.0, the pH can be adjusted with alkalis such as sodium hydroxide, potassium hydroxide, sodium carbonate, potassium carbonate, and triethanolamine. In a case where the pH exceeds 14.0, the pH can be adjusted with acids such as hydrochloric acid, sulfuric acid, lactic acid, formic acid, and citric acid. The pH adjusting agents can be used singly or in combination of two or more thereof. The pH of the treatment liquid can be measured through a well-known method such as a glass electrode method.

The static surface tension and the dynamic surface tension of the treatment liquid prepared by diluting the metal cleanser composition in water are preferably 20 to 60 mN/m and more preferably 20 to 50 mN/m from the viewpoints of detergency and rust drying properties. The static surface tension of a treatment liquid can be measured through a Wilhelmy method, and the dynamic surface tension can be measured through a maximum bubble pressure method.

The cleaning method using the metal cleanser composition of the present embodiment is not particularly limited, and cleaning methods, such as an ultrasonic method, a spraying method, a bubbling method, a barrel method, and an immersion oscillation method, in which a physical operation is added are suitably used.

The cleaning temperature is preferably 5° C. to 100° C., more preferably 10° C. to 80° C., and particularly preferably 15° C. to 80° C. from the viewpoints of detergency and economical efficiency. The cleaning time can be appropriately set according to the shape and size of an object to be cleaned, cleaning method, and the cleaning conditions.

### EXAMPLES

Hereinafter, the present invention will be described in more detail with reference to examples. However, the present invention is not limited by these examples.

### Examples 1 to 12 and Comparative Examples 1 to 30

Metal cleanser compositions were prepared according to the components and compositions (mass %) shown in Tables 1 to 6. Specifically, the metal cleanser compositions were prepared such that a component (A) was added to and mixed with a component (C) for uniformization and components (B), (D), and (E) were added to and mixed with ion exchange water (G). The obtained metal cleanser compositions of Examples 1 to 12 and Comparative Examples 1 to 30 were diluted with ion exchange water to be adjusted to a 3 mass % aqueous solution which was used as a test solution for a following evaluation test.

The details of components of *1 to *7 in the tables are as follows.

*1: Sodium polyacrylate (weight-average molecular weight of 6,000)

*2: A butyl alcohol EO (1) adduct is a compound in which, in General Formula (B), R¹ is an alkyl group having 4 carbon atoms and (AO)ₚ is a polyoxyethylene group having an average addition molar number of 1.

*3: A 2-ethylhexyl alcohol EO (1) PO (1.5) adduct is a compound in which, in General Formula (B), R¹ is an alkyl group having 8 carbon atoms, and (AO)ₚ is a polyoxyethylene group having an average addition molar number of 1 and a polyoxypropylene group having an average addition molar number of 1.5.

*4: Polyoxyethylene (18.2) polyoxypropylene (43.6) stearyl ether is a compound in which, General Formula (D-1), R⁵ is an alkyl group having 18 carbon atoms, R⁶ is a hydrogen atom, x and z are 0, and (AO)_{y} is a polyoxyethylene group having an average addition molar number of 18.2 and a polyoxypropylene group having an average addition molar number of 43.6.

*5: Polyalkylene glycol having a number average molecular weight of 2,000, an oxypropylene group content of 90 mass %, and an oxyethylene group content of 10 mass %

*6: Polyoxyethylene (23) polyoxypropylene (16) stearyl ether is a compound in which, General Formula (D-1), R⁵ is an alkyl group having 18 carbon atoms, R⁶ is a hydrogen atom, x and z are 0, and (AO)_{y} is a polyoxyethylene group having an average addition molar number of 20 and a polyoxypropylene group having an average addition molar number of 16.

*7: Acetylene glycol derivative (manufactured by Kawaken Fine Chemicals Co., Ltd.)

[Detergency Evaluation Test]

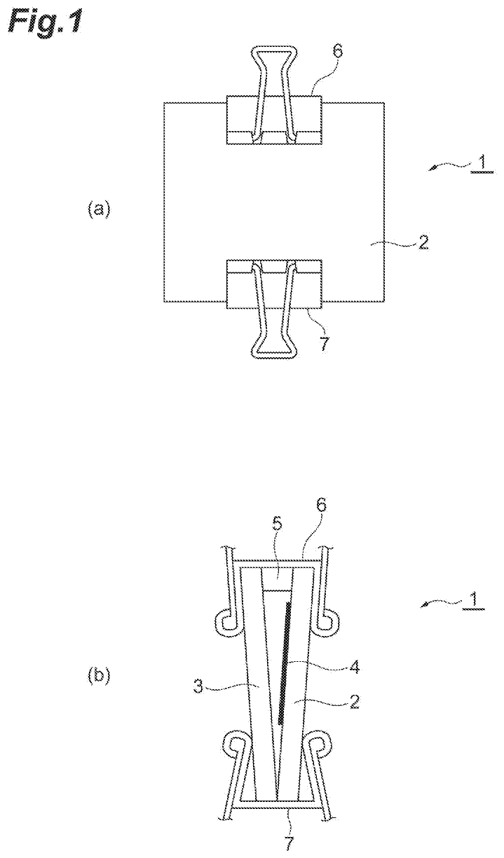

Two commercially available cold-rolled steel plates (SPCC-SD) cut into 50 mm×50 mm×1 mm were prepared as test pieces, and the surface of the test pieces was cleaned with n-hexane. The surface of one of the test pieces was coated with 0.03 g of rust preventive oil (ANTIRUST P2800 manufactured by JX Nippon Oil & Energy Corporation) as a contamination substance to prepare a contaminated sample. Thereafter, a polytetrafluoroethylene sheet (NAFLON sheet 9000-S manufactured by NICHIAS Corporation) cut to 5 mm×5 mm×1 mm was installed on an upper portion of the coated surface of the contaminated sample, the other test piece which had not been coated with a contamination substance was stacked thereon, and an upper end and a lower end were closed with a double clip. An evaluation sample was produced in this manner. FIG. 1 is a diagram illustrating a configuration of an evaluation sample. (a) of FIG. 1 is a diagram when the evaluation sample is seen from a direction orthogonal to a test piece, and (b) of FIG. 1 is a diagram when the evaluation sample is seen from a direction in which the test piece extends. In an evaluation sample 1, a test piece 2 (contaminated sample) coated with a contamination substance 4 and an uncoated test piece 3 are fixed by double clips 6 and 7 sandwiching both ends thereof. A polytetrafluoroethylene sheet 5 is interposed on one end side of both test pieces, and a gap is provided so that the contamination substance 4 does not come into contact with the test piece 3.

A 100 mL beaker was filled with each test solution of which the temperature was adjusted to 25° C., and then, an evaluation sample was immersed therein for 15 seconds. Thereafter, the evaluation sample was pulled up, dried for 30 minutes at 80° C., and allowed to cool in a desiccator for 10 minutes. The weight of the contaminated sample taken out from the evaluation sample was measured to obtain a cleaning rate from the following formula.

Cleaning rate (mass %)=[{weight (g) of contaminated sample before cleaning}−{weight (g) of contaminated sample after cleaning}×100/[{weight (g) of contaminated sample before cleaning}−{weight (g) of test piece}]

In a case where the cleaning rate is greater than or equal to 35%, it can be said that the present invention has sufficient detergency.

[Defoaming Property Evaluation Test]

50 mL of each test solution, of which the temperature was adjusted to 25° C., was poured into a 100 ml Nessler tube which was then shaken up and down 10 times for 5 seconds with an amplitude width of 20 cm. The amount of bubbles (mL) from a liquid level 15 seconds after allowing the tube to stand on a horizontal table was measured.

In a case where the amount of bubbles is less than 50 mL, it can be said that the present invention has sufficient defoaming properties.

[Rust Preventive Property Evaluation Test]

(Subject: Aluminum Alloy Die Cast)

Deburring of the surface of a commercially available 50 mm×25 mm×2 mm aluminum alloy die cast (ADC-12) with sandpaper CC1000, brightening of the cast, and removal of an oxide film were performed. Thereafter, ultrasonic cleaning was performed in n-hexane for 30 minutes, and drying was performed at room temperature to prepare a test piece.

The above-described test piece was half-immersed in a 70 mL sample bottle filled with 25 g of a test solution and was allowed to stand at 60° C. for one day. The condition of rust in the test piece was observed and evaluated according to the following criteria. Levels 2 and 3 means that the test piece has sufficient rust preventive properties.

Level 1: Area of rust in immersed portion is greater than or equal to 50%

Level 2: Area of rust in immersed portion is less than 50%

Level 3: No rusting

(Subject: Copper Alloy)

A test piece was prepared in the same manner as above except that commercially available 50 mm×25 mm×1 mm copper alloy (C3713P) was used instead of the aluminum alloy die cast, and rust preventive properties are evaluated.

TABLE 1

| | | Example 1 | Example 2 | Example 3 | Example 4 | Example 5 | Example 6 |
|---|---|---|---|---|---|---|---|
| Component | Octanoic acid triethanolamine salt | 16.3 | 16.3 | 16.3 | 16.3 | 16.3 | 16.3 |
| (A) | Sodium polyacrylate *1 | 1.0 | 1.0 | 1.0 | 1.0 | 1.0 | 1.0 |
| Component | Butyl alcohol EO (1) adduct *2 | — | — | — | 7.2 | — | — |
| (B) | 2-Ethylhexyl alcohol EO (1) | 7.2 | 7.2 | 2.4 | — | 7.2 | 7.2 |
| | PO (1.5) adduct *3 | | | | | | |
| Component | Octylphosphonic acid | 0.1 | 0.5 | 0.5 | 0.5 | 0.5 | — |
| (C) | Octanedecylphosphonic acid | — | — | — | — | — | 0.5 |
| Component | Polyoxyethylene (18.2) | — | — | — | — | 0.06 | — |
| (D) | polyoxypropylene (43.6) | | | | | | |
| | stearyl ether *4 | | | | | | |
| Component | Polyalkylene glycol *5 | — | — | — | — | 0.6 | — |
| (E) | | | | | | | |
| Ion exchange water | | Remainder | Remainder | Remainder | Remainder | Remainder | Remainder |
| Defoaming | Foam volume (mL) after 15 seconds | 4.5 | 8.2 | 28.0 | 40 | 3.0 | 31.0 |
| properties | at 25° C. | | | | | | |
| Rust | Aluminum alloy die cast (ADC-12), | 3 | 3 | 3 | 3 | 3 | 3 |
| preventive | 60° C., one day (level) | | | | | | |
| properties | | | | | | | |
| Detergency | Cleaning rate (%) of steel plate | 53.7 | 47.0 | 41.3 | 42.4 | 43.1 | 42.0 |
| | (SPCC-SD) for 15 seconds at 25° C. | | | | | | |

TABLE 2

| | | Example 7 | Example 8 | Example 9 | Example 10 | Example 11 | Example 12 |
|---|---|---|---|---|---|---|---|
| Component | Octanoic acid triethanolamine salt | 16.3 | 16.3 | 16.3 | 16.3 | 16.3 | 16.3 |
| (A) | Sodium polyacrylate *1 | 1.0 | 1.0 | 1.0 | 1.0 | 1.0 | 1.0 |
| Component | 2-Ethylhexyl alcohol EO (1) | 7.2 | 7.2 | 7.2 | 7.2 | 7.2 | 7.2 |
| (B) | PO (1.5) adduct *3 | | | | | | |
| Component | Benzotriazole | 0.01 | 0.05 | 0.1 | 0.5 | 1 | 0.5 |
| (C) | | | | | | | |
| Component | Polyoxyethylene (18.2) | — | — | — | — | — | 0.06 |
| (D) | polyoxypropylene (43.6) | | | | | | |
| | stearyl ether *4 | | | | | | |
| Component | Polyalkylene glycol *5 | — | — | — | — | — | 0.6 |
| (E) | | | | | | | |
| Ion exchange water | | Remainder | Remainder | Remainder | Remainder | Remainder | Remainder |
| Defoaming | Foam volume (mL) after 15 seconds | 3.0 | 3.0 | 3.0 | 3.0 | 3.0 | 2.0 |
| properties | at 25° C. | | | | | | |
| Rust | Copper alloy (C3713P), 60° C., | 3 | 3 | 3 | 3 | 3 | 3 |
| preventive | one day (level) | | | | | | |
| properties | | | | | | | |
| Detergency | Cleaning rate (%) of steel plate | 54.7 | 56.7 | 50.6 | 47.9 | 44.6 | 44.0 |
| | (SPCC-SD) for 15 seconds at 25° C. | | | | | | |

TABLE 3

| | | Compar- | Compar- | Compar- | Compar- | Compar- | Compar- | Compar- | Compar- |
|---|---|---|---|---|---|---|---|---|---|
| | | ative | ative | ative | ative | ative | ative | ative | ative |
| | | Exam- | Exam- | Exam- | Exam- | Exam- | Exam- | Exam- | Exam- |
| | | ple 1 | ple 2 | ple 3 | ple 4 | ple 5 | ple 6 | ple 7 | ple 8 |
| Component | Octanoic acid triethanolamine | — | — | — | — | — | — | — | — |
| (A) | salt | | | | | | | | |
| | Sodium polyacrylate *1 | — | — | — | — | — | — | — | — |
| Component | 2-Ethylhexyl alcohol EO (1) | — | — | — | — | — | — | — | — |
| (B) | PO (1.5) adduct *3 | | | | | | | | |
| Component | Octylphosphonic acid | 0.5 | — | — | — | — | — | — | — |
| (C) | | | | | | | | | |
| Other rust | Sodium dodecyl diphenyl ether | — | 0.5 | — | — | — | — | — | — |
| inhibitors | disulfonate | | | | | | | | |
| | Phosphoric acid butyl ester | — | — | 0.5 | — | — | — | — | — |
| | Sodium nitrite | — | — | — | 0.5 | — | — | — | — |
| | Sodium gluconate | — | — | — | — | 0.5 | — | — | — |
| | 3-(2-Benzothiazylthio)propionic | — | — | — | — | — | 1.0 | — | — |
| | acid | | | | | | | | |
| | (2- Benzothiazylthio)acetic | — | — | — | — | — | — | 3.0 | — |
| | acid | | | | | | | | |
| | 4-t-Butyl benzoic acid | — | — | — | — | — | — | — | 1.5 |
| Component | Polyoxyethylene (23) | — | — | — | — | — | — | — | — |
| (D) | polyoxypropylene (16) | | | | | | | | |
| | stearyl ether *6 | | | | | | | | |
| Others | Triethanolamine | — | — | 0.39 | — | — | 0.62 | 1.99 | 1.26 |
| | D-sorbitol | — | — | — | — | 0.4 | — | — | — |
| Ion exchange water | | Remainder | Remainder | Remainder | Remainder | Remainder | Remainder | Remainder | Remainder |
| Defoaming | Foam volume (mL) after 15 | 3.0 | 8.0 | 3.3 | 2.9 | 3.0 | 4.2 | 4.6 | 4.4 |
| properties | seconds at 25° C. | | | | | | | | |
| Rust | Aluminum alloy die cast | 3 | 2 | 3 | 2 | 3 | 3 | 3 | 3 |
| preventive | (ADC-12), 60° C., | | | | | | | | |
| properties | one day (level) | | | | | | | | |
| Detergency | Cleaning rate (%) of steel | 23.0 | 27.2 | 29.3 | 28.6 | 22.9 | 23.3 | 25.4 | 21.5 |
| | plate (SPCC-SD) for 15 | | | | | | | | |
| | seconds at 25° C. | | | | | | | | |

TABLE 4

| | | Compar- | Compar- | Compar- | Compar- | Compar- | Compar- | Compar- | Compar- |
|---|---|---|---|---|---|---|---|---|---|
| | | ative | ative | ative | ative | ative | ative | ative | ative |
| | | Exam- | Exam- | Exam- | Exam- | Exam- | Exam- | Exam- | Exam- |
| | | ple 9 | ple 10 | ple 11 | ple 12 | ple 13 | ple 14 | ple 15 | ple 16 |
| Component | Octanoic acid triethanolamine | 16.3 | 16.3 | 16.3 | 16.3 | 16.3 | 16.3 | 16.3 | — |
| (A) | salt | | | | | | | | |
| | Sodium polyacrylate *1 | 1.0 | 1.0 | 1.0 | 1.0 | 1.0 | 1.0 | 1.0 | — |
| Component | 2-Ethylhexyl alcohol EO (1) | 7.2 | 7.2 | 7.2 | 7.2 | 7.2 | 7.2 | 7.2 | — |
| (B) | PO (1.5) adduct *3 | | | | | | | | |
| Component | Octylphosphonic acid | — | — | — | — | — | — | — | — |
| (C) | | | | | | | | | |
| Other rust | Sodium dodecyl diphenyl ether | 0.5 | — | — | — | — | — | — | — |
| inhibitors | disulfonate | | | | | | | | |
| | Phosphoric acid butyl ester | — | 0.5 | — | — | — | — | — | — |
| | Sodium nitrite | — | — | 0.5 | — | — | — | — | 0.5 |
| | Sodium gluconate | — | — | — | 0.1 | — | — | — | — |
| | 3-(2-Benzothiazylthio)propionic | — | — | — | — | 1.0 | — | — | — |
| | acid | | | | | | | | |
| | (2- Benzothiazylthio)acetic acid | — | — | — | — | — | 3.0 | — | — |
| | 4-t-Butyl benzoic acid | — | — | — | — | — | — | 1.5 | — |
| Component | Polyoxyethylene (23) | — | — | — | — | — | — | — | 20 |
| (D) | polyoxypropylene (16) | | | | | | | | |
| | stearyl ether *6 | | | | | | | | |
| Others | Triethanolamine | — | 0.39 | — | — | 0.62 | 1.99 | 1.26 | — |
| | D-sorbitol | — | — | — | 0.4 | — | — | — | — |
| Ion exchange water | | Remainder | Remainder | Remainder | Remainder | Remainder | Remainder | Remainder | Remainder |
| Defoaming | Foam volume (mL) after 15 | 27.0 | 3.0 | 2.2 | 4.5 | 3.1 | 3.4 | 3.2 | 68.8 |
| properties | seconds at 25° C. | | | | | | | | |
| Rust | Aluminum alloy die cast | 1 | 1 | 1 | 1 | 1 | 1 | 1 | 1 |
| preventive | (ADC-12), 60° C., one day | | | | | | | | |
| properties | (level) | | | | | | | | |
| Detergency | Cleaning rate (%) of steel | 44.6 | 48.8 | 50.9 | 50.2 | 44.5 | 43.1 | 44.9 | 27.6 |
| | plate (SPCC-SD) for 15 | | | | | | | | |
| | seconds at 25° C. | | | | | | | | |

TABLE 5

| | | Compar- | Compar- | Compar- | Compar- | Compar- | Compar- | Compar- |
|---|---|---|---|---|---|---|---|---|
| | | ative | ative | ative | ative | ative | ative | ative |
| | | Exam- | Exam- | Exam- | Exam- | Exam- | Exam- | Exam- |
| | | ple 17 | ple 18 | ple 19 | ple 20 | ple 21 | ple 22 | ple 23 |
| Component | Octanoic acid triethanolamine | — | — | — | — | — | — | — |
| (A) | salt | | | | | | | |
| | Sodium polyacrylate *1 | — | — | — | — | — | — | — |
| Component | 2-Ethylhexyl alcohol EO (1) | — | — | — | — | — | — | — |
| (B) | PO (1.5) adduct *3 | | | | | | | |
| Component | Benzotriazole | 0.5 | — | — | — | — | — | — |
| (C) | Acetylenol E00 *7 | — | 0.5 | — | — | — | — | — |
| | Sodium dodecyl diphenyl ether | — | — | 0.5 | — | — | — | — |
| | disulfonate | | | | | | | |
| Other rust | Sodium nitrite | — | — | — | 0.5 | — | — | — |
| inhibitors | 3-(2-Benzothiazylthio)propionic | — | — | — | — | 1.0 | — | — |
| | acid | | | | | | | |
| | (2- Benzothiazylthio)acetic | — | — | — | — | — | 3.0 | — |
| | acid | | | | | | | |
| | 4-t-Butyl benzoic acid | — | — | — | — | — | — | 1.5 |
| Component | Polyoxyethylene (23) | — | — | — | — | — | — | — |
| (D) | polyoxypropylene (16) | | | | | | | |
| | stearyl ether *6 | | | | | | | |
| Others | Triethanolamine | — | — | — | — | 0.62 | 1.99 | 1.26 |
| Ion exchange water | | Remainder | Remainder | Remainder | Remainder | Remainder | Remainder | Remainder |
| Defoaming | Foam volume (mL) after 15 | 4.0 | 3.0 | 8.0 | 2.9 | 4.2 | 4.6 | 4.4 |
| properties | seconds at 25° C. | | | | | | | |
| Rust | Copper alloy (C3713P), | 3 | 3 | 3 | 3 | 3 | 3 | 3 |
| preventive | 60° C., one day (level) | | | | | | | |
| properties | | | | | | | | |
| Detergency | Cleaning rate (%) of steel | 26.3 | 26.0 | 25.4 | 29.3 | 22.9 | 18.9 | 20.5 |
| | plate (SPCC-SD) for 15 | | | | | | | |
| | seconds at 25° C. | | | | | | | |

TABLE 6

| | | Compar- | Compar- | Compar- | Compar- | Compar- | Compar- | Compar- |
|---|---|---|---|---|---|---|---|---|
| | | ative | ative | ative | ative | ative | ative | ative |
| | | Exam- | Exam- | Exam- | Exam- | Exam- | Exam- | Exam- |
| | | ple 24 | ple 25 | ple 26 | ple 27 | ple 28 | ple 29 | ple 30 |
| Component | Octanoic acid triethanolamine | 16.3 | 16.3 | 16.3 | 16.3 | 16.3 | 16.3 | — |
| (A) | salt | | | | | | | |
| | Sodium polyacrylate *1 | 1.0 | 1.0 | 1.0 | 1.0 | 1.0 | 1.0 | — |
| Component | 2-Ethylhexyl alcohol EO (1) | 7.2 | 7.2 | 7.2 | 7.2 | 7.2 | 7.2 | — |
| (B) | PO (1.5) adduct *3 | | | | | | | |
| Component | Benzotriazole | — | — | — | — | — | — | — |
| (C) | | | | | | | | |
| | Acetylenol E00 *7 | 0.5 | — | — | — | — | — | — |
| | Sodium dodecyl diphenyl ether | — | 0.5 | — | — | — | — | — |
| | disulfonate | | | | | | | |
| Other rust | Sodium nitrite | — | — | 0.5 | — | — | — | 0.5 |
| inhibitors | 3-(2-Benzothiazylthio)propionic | — | — | — | 1.0 | — | — | — |
| | acid | | | | | | | |
| | (2- Benzothiazylthio)acetic acid | — | — | — | — | 3.0 | — | — |
| | 4-t-Butyl benzoic acid | — | — | — | — | — | 1.5 | — |
| Component | Polyoxyethylene (23) | — | — | — | — | — | — | 20 |
| (D) | polyoxypropylene (16) | | | | | | | |
| | stearyl ether *6 | | | | | | | |
| Others | Triethanolamine | — | — | — | 0.62 | 1.99 | 1.26 | — |
| Ion exchange water | | Remainder | Remainder | Remainder | Remainder | Remainder | Remainder | Remainder |
| Defoaming | Foam volume (mL) after 15 | 3.0 | 27.0 | 2.2 | 3.1 | 3.4 | 3.2 | 68.8 |
| properties | seconds at 25° C. | | | | | | | |
| Rust | Copper alloy (C3713P), | 1 | 1 | 1 | 1 | 1 | 1 | 1 |
| preventive | 60° C., one day (level) | | | | | | | |
| properties | | | | | | | | |
| Detergency | Cleaning rate (%) of steel | 47.6 | 47.0 | 50.9 | 44.5 | 40.5 | 42.1 | 27.6 |
| | plate (SPCC-SD) for 15 | | | | | | | |
| | seconds at 25° C. | | | | | | | |

As shown in Tables 1 and 2, it was confirmed that cleanser compositions of Examples 1 to 12 have excellent detergency and defoaming properties even under cleaning conditions of 25° C. and that hardly cause rust on a metal surface.

### INDUSTRIAL APPLICABILITY

According to the present invention, it is possible to provide a cleanser composition with which it is possible to obtain sufficient detergency for various kinds of metal while sufficiently suppressing generation of bubbles even at room temperature and rust hardly occurs on the surface of metal after cleaning. Accordingly, in cleaning of a metal or alloy member, it is possible to perform a cleaning step, which has been performed at a high temperature so far, at normal temperature and to expect reduction in energy costs since it is unnecessary to heat a cleaning bath.

### REFERENCE SIGNS LIST

1 . . . evaluation sample, 2, 3 . . . test piece, 4 . . . contamination substance, 5 . . . polytetrafluoroethylene sheet, 6,7 . . . double clip

1. A metal cleanser composition comprising:
(A) at least one carboxylic acid compound selected from the group consisting of an aliphatic monocarboxylic acid, a polycarboxylic acid, and a neutral salt thereof;
(B) a compound represented by General Formula (B); and
(C) at least one compound selected from the group consisting of a compound represented by General Formula (C-1) and a salt thereof, a compound represented by General Formula (C-2), and a compound represented by General Formula (C-3), 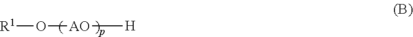
[in Formula (B), R¹ represents an alkyl group having 1 to 8 carbon atoms or an alkenyl group having 2 to 8 carbon atoms, AO represents an oxyalkylene group having 2 to 4 carbon atoms, and p represents an average addition molar number of the oxyalkylene group and is within a range of 1 to 5],
R²—(H₂PO₃)_{q} (C-1)
[in Formula (C-1), R² represents a linear or branched alkyl group or alkenyl group having 2 to 30 carbon atoms, and q represents an integer of 1 to 10], 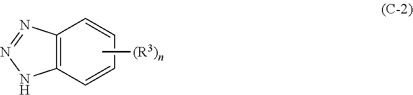
[in Formula (C-2), R³ represents a linear or branched alkyl group having 1 to 10 carbon atoms or a linear or branched alkenyl group having 2 to 10 carbon atoms, and n represents 0 or 1], and 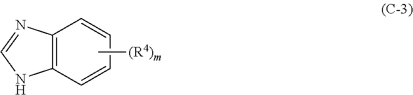
[in Formula (C-3), R⁴ represents a linear or branched alkyl group having 1 to 20 carbon atoms or a linear or branched alkenyl group having 2 to 20 carbon atoms, and m represents 0 or 1].

2. The metal cleanser composition according to claim 1, wherein a content of (A) is 1 to 40 mass %, a content of (B) is 0.1 to 15 mass %, and a content of (C) is 0.001 to 5.0 mass % based on a total amount of the metal cleanser composition.

3. The metal cleanser composition according to claim 1, comprising: a compound in which R¹ represents a linear or branched alkyl group or alkenyl group having 8 carbon atoms, AO represents an oxyalkylene group having 2 to 4 carbon atoms, and p is within a range of 1 to 5 in Formula (B), as the compound represented by General Formula (B).

4. The metal cleanser composition according to claim 2, comprising: a compound in which R¹ represents a linear or branched alkyl group or alkenyl group having 8 carbon atoms, AO represents an oxyalkylene group having 2 to 4 carbon atoms, and p is within a range of 1 to 5 in Formula (B), as the compound represented by General Formula (B).
